(19) United States
(12) Patent Application Publication
(10) Pub. No.: US 2026/0320659 A1
(43) Pub. Date: Oct. 15, 2026

(54) SYSTEMS AND METHODS TO AUTOMATE AUDITING AND GENERATION OF VEHICLE REPAIR ESTIMATES

(71) Applicant: ZOOMLY, L.L.C., Mapleton, UT (US)

(72) Inventors: Roger Comstock, Mapleton, UT (US); Nicholas D. Roman, Lehi, UT (US); Bryan Adams, South Jordan, UT (US); Nathan S. Bushman, Pleasant Grove, UT (US)

(21) Appl. No.: 19/647,640

(22) Filed: Apr. 14, 2026

Related U.S. Application Data
(60) Provisional application No. 63/788,566, filed on Apr. 14, 2025.

(51) Int. Cl. G06Q 30/0283; G06Q 10/20; G06Q 30/08; G10L 15/26

(52) U.S. Cl. CPC G06Q 30/0284; G06Q 10/20; G06Q 30/08; G10L 15/26

(57) ABSTRACT

A computer-implemented system may include a processor and a memory storing instructions. The processor may receive estimate data that includes an existing vehicle repair estimate, a repair description, or vehicle details. The processor may execute a text AI model to extract values including shop details, owner details, estimate vehicle details, repair details, part details, or estimate details. The processor may execute comparison AI model to compare the repair details and verified repair procedure details to identify verified repair details. The processor may execute the comparison AI model to compare the part details and a verified part details to identify verified part details. The processor may calculate verified estimate details including labor cost, part cost, or total cost. The processor may generate a repair estimate based on the verified repair details, the verified part details, and the verified estimate details.

### CROSS-REFERENCE TO RELATED APPLICATION

This patent application claims the benefit of and priority to U.S. Provisional App. No. 63/788,566 filed Apr. 14, 2025 titled “AUTOMATING AND AUDITING VEHICLE REPAIR ESTIMATES,” which is incorporated in the present disclosure by reference in its entirety.

### FIELD

The embodiments discussed in the present disclosure are related to systems and methods to automate auditing and generation of vehicle repair estimates.

### BACKGROUND

Unless otherwise indicated in the present disclosure, the materials described in the present disclosure are not prior art to the claims in the present application and are not admitted to be prior art by inclusion in this section.

When a vehicle requires repair, a vehicle owner typically brings the vehicle to a repair shop, where a technician inspects the vehicle and assesses the damage or mechanical issues present. Based on this inspection, the technician generates a repair estimate that includes various details and information. The information may include itemized labor, itemized parts, associated labor time, expected labor costs, or expected part costs. However, the generation or auditing of repair estimates presents multiple challenges. For example, even with a repair estimate, the vehicle owner may have difficulty determining the accuracy of the information included in the repair estimate because the information included in the repair estimate may be inaccurate. As another example, the repair shop may have difficulty generating repair estimates that are going to be accepted by the vehicle owner. As yet another example, the repair shop may have difficulty acquiring parts to be used for the repair in a manner that avoids unnecessary or excessive cost, as for example the repair shop may find it difficult to find suitable aftermarket parts as alternatives to typically more expensive original equipment manufacturer (OEM) parts.

The subject matter claimed herein is not limited to the embodiments that solve any disadvantages or that operate only in environments such as those described above. Rather, this background is only provided to illustrate one example technology area where some embodiments described herein may be practiced.

### SUMMARY

This Summary is provided to introduce a selection of concepts in a simplified form that are further described below in the Description of Embodiments. This Summary is not intended to identify key features or essential characteristics of the claimed subject matter, nor is it intended to be used as an aid in determining the scope of the claimed subject matter.

In general, example embodiments described herein relate to automated generation of a vehicle repair estimate and automated auditing of an existing vehicle repair estimate. The example methods disclosed herein may determine labor procedures, labor times, labor costs, or suitable or cost-effective parts with their costs, such as aftermarket parts which are typically cheaper than OEM parts, or alternately the cheapest part among a set of equivalent and/or compatible parts across a range of possible part options from different part sellers, and increase the utilization of repair shop personnel and resources.

In one example embodiment, a method to automate auditing an existing vehicle repair estimate may include utilizing a generative AI model to analyze the existing repair estimate in order to extract information from the existing repair estimate information such as the labor procedures, labor times, labor costs, parts and part costs. The method may also include cross-referencing the extracted information with known sources of accurate information for labor procedures, labor times, labor costs, and cost-effective alternative parts and their costs. The method may further include determining a more accurate and/or more cost-effective repair estimate based on the cross-referencing, which may then be presented to one or more vehicle repair shops, enabling them to opt-in for additional business.

In another example embodiment, a method to automate the creation of a vehicle repair estimate may include a vehicle owner providing, verbally; in text form; in image form; or any other appropriate form, a description of a vehicle repair, and may include utilizing a generative AI model to perform a comparison of the provided description to known and accurate repair procedures and their descriptions in order to determine the best matching procedures. The method may further include, identifying, using known sources of accurate information for those procedures, accurate information for labor procedures, labor times, labor costs, and cost-effective parts and their costs, in order to create an accurate and/or cost-effective estimate. Further, the method may include presenting the created estimate to one or more vehicle repair shops, enabling them to opt-in for additional business.

The object and advantages of the embodiments will be realized and achieved at least by the elements, features, and combinations particularly pointed out in the claims. It is to be understood that both the foregoing descriptions and the following descriptions are exemplary and explanatory and are not restrictive of the invention.

### BRIEF DESCRIPTION OF THE DRAWINGS

Example embodiments will be described and explained with additional specificity and detail through the use of the accompanying drawings in which:

FIG. 1 illustrates a block diagram of an example environment to automate auditing and generation of repair estimates,

FIG. 2 illustrates a block diagram of example components, example systems, or example data sources used to estimate vehicle repair costs,

FIG. 3 illustrates an example schematic flowchart diagram of an example method to estimate vehicle repair costs given an existing repair estimate and/or a repair description, utilizing the components, the systems, or the data sources of FIG. 1 or 2; and

FIG. 4 illustrates an example computing system that may be used to automate auditing and generation of repair estimates,

all according to at least one embodiment described in the present disclosure.

### DETAILED DESCRIPTION

A repair estimate serves as a formal document that details itemized labor, itemized parts, associated labor time, expected labor costs, or expected part costs associated with repairing a damaged or malfunctioning vehicle. The repair estimate may also include information identifying the vehicle, such as the vehicle identification number (VIN), production year, make, model, trim level, engine type, or mileage. In addition, the repair estimate may include information identifying the repair shop or the vehicle owner. Further, the repair estimate may detail expected repair procedures associated with repairing the vehicle. The repair estimate may be generated in a variety of formats, including a printed paper document, a digital document such as a portable document format (PDF) or a spreadsheet. The repair estimate may provide a comprehensive financial picture associated with the repair of the vehicle for the vehicle owner, a financially relevant party (e.g., an insurance company), or any other appropriate party.

The process to generate, audit, or both a repair estimate is typically a labor-intensive process performed by a technician that possesses detailed knowledge of repair procedures, labor, cost of parts, or any other appropriate information. For example, the technician may reference industry-standard labor time guides to determine expected time to perform the repair. As another example, the technician may reference similar guides provided by parts suppliers (e.g., original equipment manufacturer (OEM) suppliers, aftermarket parts retailers, parts wholesalers, or parts vendors). The different parts suppliers may offer the same or equivalent parts at differing price points, quality levels, or both.

The technician may generate the repair estimate using only time guides, parts guides, or both that are known to the technician. This introduces difficulties and limitations into the repair estimate. Because the technician is constrained to only those known guides, the scope of possible parts that can be used, or repair procedures that can be employed to repair the vehicle, may be narrowed. For example, this may limit the repair estimate to more expensive parts because the technician is unaware of more cost-effective parts available from alternative sources. Similarly, this may limit the repair estimate to more expensive repair procedures because the technician is unaware of more efficient or cost-effective repair procedures that could reduce labor time and associated costs. Accordingly, using only time guides or parts guides that are known to the technician may result in repair estimates that are inaccurate, incomplete, or financially disadvantageous to one or more parties involved in the repair of the vehicle.

The vehicle owner, the technician, or both may audit the repair estimate. To audit the repair estimate, the vehicle owner or the technician may review each part, repair procedure, labor cost, or any other information included in the repair estimate to verify that the information is accurate or consistent. This review process may be susceptible to human error, inconsistency, or inefficiency.

Some vehicle owners may lack technical expertise or knowledge to audit the repair estimate. For example, these vehicle owners may lack knowledge regarding repair procedures, associated labor times, or part costs listed in the repair estimate. Accordingly, the vehicle owners may be unable to meaningfully audit the repair estimate. Similarly, some technicians may be unable to audit the repair estimate due to scheduling conflicts, workload constraints, or other competing obligations. Accordingly, the audit of the repair estimate by the technician may be delayed or entirely prevented. Additionally or alternatively, the technician may lack technical expertise or knowledge for a specific make, model, trim level, or engine type of the vehicle to be repaired, which may cause the technician to be unable to meaningfully audit the repair estimate.

The present disclosure provides techniques for avoiding or reducing the technical difficulties described above. Some embodiments described in the present disclosure include systems and methods to automate the generation, auditing, or both of the repair estimate. In particular, systems of the present disclosure may use artificial intelligence (AI) models to generate, audit, or both the repair estimate. The system may apply the AI models to extract and identify key information from estimate data. In addition, the AI models may match repair procedures against a database of repair procedures or match parts against parts available from a range of suppliers to identify accurate, cost-effective, reliable, or profitable parts or labor times. Using the results of these comparisons, the system may generate an accurate repair estimate.

The term “accurate” as used herein may refer to information or details that have been verified against one or more data sources or parts that have been selected from among available suppliers to reflect verified pricing, compatibility, and quality for the identified vehicle and repair procedures.

The system may facilitate a repair shop opt-in and bidding process to enable repair shops to either elect to perform the repair of the vehicle or compete for the work through an auction mechanism. The system may provide the repair estimate to participating repair shops, each of which may review the repair estimate. A repair shop that wishes to perform the repair may opt-in directly, thereby accepting the repair estimate as generated. Alternatively, where multiple repair shops are interested in performing the repair, the system may facilitate a competitive bidding process in which the repair shops submit bids for the work. For example, the system may allow the repair shops to submit their bids in an open auction format or a blind auction format. The open auction format may allow the associated repair shops to view bids submitted by other repair shops. The blind auction format may prevent the associated shops from viewing bids submitted by other repair shops. The system may select a repair shop based on criteria such as bid price, repair shop rating, geographic proximity to the vehicle owner, or any other appropriate criteria. In addition, the system may facilitate the scheduling of the repair, the ordering of parts, or both.

Therefore, the embodiments of the present disclosure may generate accurate repair estimates that are based on verified labor times, optimally selected parts, or both. In addition, the embodiments of the present disclosure may facilitate downstream workflows for the repair shops. Further, the embodiments of the present disclosure may facilitate scheduling of the repair, ordering of parts, or both. Additionally, the embodiments of the present disclosure may reduce human error or human limitations when the repair estimate is generated, audited, or both.

The phrase “AI model” as used herein refers to a program that detects specific patterns in data or information using one or more data sets. The phrase “structured data” as used herein refers to data that has a standardized format for access and typically includes metadata such as field names and/or field tags and/or field data-type information, and may be illustrated by, but not limited to, examples such as XML, JSON, TOML and CSV. The phrase “unstructured data” as used herein refers to data that can't be classified as “structured data.” The phrase “fuzzy comparison” as used herein refers to the use of an AI model and/or other algorithm to match data, which is equivalent or approximately equivalent, where approximately equivalent data is not identical but is conceptually similar. The term “AI prompt” as used herein refers to at least a portion of the input to an AI model. The term “interface” as used herein refers to any mechanism that enables units of computer program logic to communicate and/or interoperate. The term “search engine” as used herein refers to systems such as Google Search, Microsoft Bing Search, Yahoo Search, Duckduckgo search, Brave search, and any other such search services, including any AI models which provide query/response type of services. The term “microservice” as used herein refers to software composed as independent services that communicate with interfaces. It is understood that all definitions are provided by way of example rather than limitation, and the scope of any interpretation of any terms should be the broadest possible interpretation in the art.

Embodiments of the present disclosure will be explained with reference to the accompanying figures. It is to be understood that the figures are diagrammatic and schematic representations of such example embodiments, and are not limiting, nor are they necessarily drawn to scale. In the figures, features with like numbers indicate like structure and function unless described otherwise.

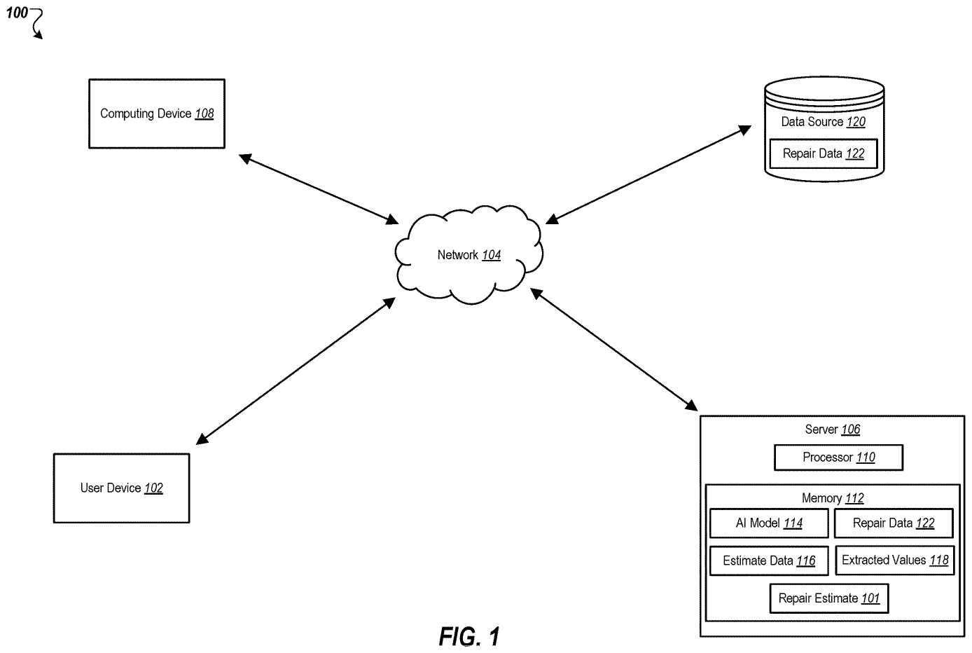

FIG. 1 illustrates a block diagram of an example operational environment 100 to automate auditing and generation of vehicle repair estimates, in accordance with at least one embodiment described in the present disclosure. The environment 100 includes a user device 102, a network 104, a server 106, a computing device 108, and a data source 120.

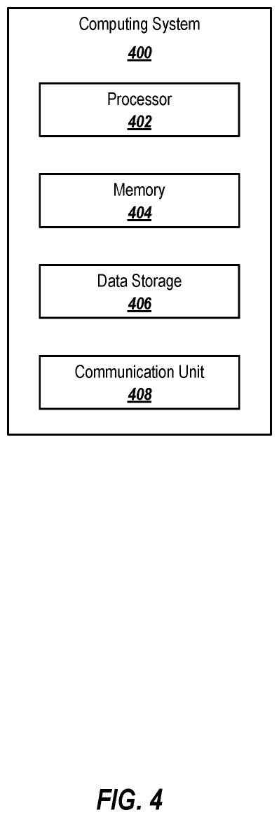

The user device 102 may include a computing device capable of communicating over the network 104, such as a desktop computer, a laptop computer, a tablet, a smartphone, or another suitable computing device. An example of the user device 102 is illustrated and described below in relation to FIG. 4. The computing device 108 may include a computing device capable of communicating over the network 104, such as a desktop computer, a laptop computer, a tablet computer, a mobile phone, a smartphone, or another suitable computing device. A single instance of the computing device 108 is illustrated and described in relation to FIG. 1. However, the environment 100 may include any appropriate number of computing devices. In addition, a single instance of the data source 120 is illustrated and described in relation to FIG. 1. However, the environment 100 may include any appropriate number of data sources.

The user device 102 may be operated by a vehicle owner, an insurance company, or any other appropriate person in the generation or auditing of a repair estimate 101 (e.g., a vehicle repair estimate). The computing devices 108 may be operated by a repair shop, a parts supplier, a technician, or any other appropriate party involved in the generation or auditing of the repair estimate 101.

The server 106 may receive estimate data 116 associated with a repair of a vehicle (not shown). For example, the server 106 may receive the estimate data 116 from the computing device 108 via the network 104. The estimate data 116 may include raw details of a repair of a vehicle, such as an existing repair estimate, a description of an inspection of the vehicle in verbal, text, image, or document form, or a description of vehicle details that identify the vehicle to be repaired. The server 106 may receive repair data 122 from the data source 120. The repair data 122 may include information such as verified (e.g., accurate) repair procedure details, verified repair part details, or parts associated with a given repair procedure.

As described in more detail below, the server 106 may execute the AI model 114 to generate extracted values 118 based on the estimate data 116. The extracted values 118 may include repair shop details, vehicle owner details, estimate vehicle details, repair procedure details, repair part details, or estimate details. In addition, as described in more detail below, the AI model 114 may use the extracted values 118, the repair data 122, or both to generate the repair estimate 101. For example, the AI model 114 may process the extracted values 118 to generate the repair estimate 101 and use the repair data 122 to verify the repair estimate 101. As another example, the AI model 114 may process the extracted values 118 and the repair data 122 to generate the repair estimate 101.

The server 106 may provide the repair estimate 101 to the computing device 108 to be audited by a repair shop that is associated with the generation of the repair estimate 101. The repair shop may use the computing device 108 to audit the repair estimate 101. Upon receiving the repair estimate 101, a technician (not shown) may audit the information (e.g., itemized labor, itemized parts, associated labor times, expected labor costs, or expected part costs) of the repair estimate 101. The computing device 108 may display the repair estimate 101 to allow the technician to audit the repair estimate 101. The technician may compare the information (e.g., the repair procedure details, repair part details, or estimate details) in the repair estimate 101 against their knowledge or records to confirm that the information in the repair estimate 101 is appropriate for the vehicle to be repaired.

The repair shop may use the computing device 108 to submit feedback, request modifications, or indicate acceptance of the repair estimate 101. For example, the repair shop may flag discrepancies identified during the audit, such as incorrect part numbers, inaccurate labor times, or missing repair procedures. The server 106 may process the feedback received from the computing device 108 and, where appropriate, execute the AI model 114 to revise the repair estimate 101 based on the identified discrepancies.

Upon approval of the repair estimate 101 by the repair shop, the server 106 may provide the repair estimate 101 to the user device 102. The vehicle owner may use the user device 102 to audit the repair estimate 101. Upon receiving the repair estimate 101, the user device 102 may display the repair estimate 101 to the vehicle owner. The vehicle owner may audit the information (e.g., itemized labor, itemized parts, associated labor times, expected labor costs, or expected part costs) in the repair estimate 101. The vehicle owner may navigate through the repair estimate 101 using the user device 102 to examine individual line items, including specific repair procedures, associated parts, and corresponding costs.

The vehicle owner may use the user device 102 to submit feedback, request modifications, or indicate acceptance of all or part of the repair estimate 101. For example, the vehicle owner may identify line items in the repair estimate 101 that appear inconsistent with the vehicle owner's understanding of the scope of the repair procedures. The vehicle owner may flag such line items using the user device 102, and the server 106 may receive the feedback and execute the AI model 114 to revise the repair estimate 101 accordingly. Additionally, the vehicle owner may use the user device 102 to request modifications to the repair estimate 101, such as substituting parts from alternative suppliers or adjusting the scope of the repair procedures.

Upon receiving approval of the repair estimate 101 from the vehicle owner, the server 106 may initiate a bidding process in which the repair estimate 101 is distributed to one or more repair shops to bid on. The server 106 may transmit the approved repair estimate 101 to the computing devices 108 associated with different repair shops. The repair shops may review the repair estimate 101. A repair shop may opt-in directly by accepting the repair estimate 101 as presented. Where multiple repair shops express interest in performing the repair, the server 106 may facilitate a competitive bidding process in which the repair shops submit bids. The server 106 may conduct the bidding process in either an open auction format, in which participating repair shops may view bids submitted by other repair shops, or a blind auction format, in which the bids submitted by each repair shop are not visible to other participating repair shops.

Upon receiving bids from multiple repair shops, the server 106 may execute the AI model 114 to evaluate the submitted bids based on one or more selection criteria. Such criteria may include bid price, repair shop rating, geographic proximity of the repair shop to the vehicle owner, availability of the repair shop to perform the repair within a desired timeframe, or any other appropriate criteria. Upon selecting a repair shop based on the evaluated criteria, the server 106 may notify the selected repair shop via the computing device 108 and may notify the vehicle owner via the user device 102. As described in more detail below, the server 106 may facilitate or schedule the repair at the selected repair shop. In addition, as described in more detail below, the server 106 may order the parts identified in the repair estimate 101 from the appropriate suppliers. Further, as described in more detail below, the server 106 may facilitate financial transactions associated with the repair, including processing payments from the vehicle owner or a financially relevant party such as an insurance company.

The server 106 may be a computer system that provides services to the user device 102, the computing device 108, or both over the network 104. The server 106 may include hardware components such as a processor 110 and a memory 112. The processor 110 may include a central processing unit (CPU), a microprocessor (μP), a microcontroller (μC), a digital signal processor (DSP), a field-programmable gate array (FPGA), an application-specific integrated circuit (ASIC), or any combination thereof. The processor 110 may be configured to execute computer instructions that, when executed, cause the processor 110 or the server 106 to perform or control performance of one or more of the operations described herein with respect to automating the auditing and generation of vehicle repair estimates. The processor 110 may be implemented using a combination of hardware and software. In the present disclosure, operations described as being performed by the processor 110 or the server 106 may include operations that the processor 110 or the server 106 directs a corresponding system to perform.

The memory 112 may include a storage medium such as a RAM, persistent or non-volatile storage such as ROM, EEPROM, CD-ROM, or other optical disk storage, magnetic disk storage or other magnetic storage device, NAND flash memory or other solid state storage device, or other persistent or non-volatile computer storage medium. The memory 112 may store computer instructions that may be executed by the processor 110 or the server 106 to perform or control performance of one or more of the operations described herein with respect to automating the auditing and generation of vehicle repair estimates. In addition, the memory 112 may store the AI model 114, the repair data 122, the estimate data 116, or the extracted values 118 persistently and/or at least temporarily.

The network 104 may include any communication network configured for communication of signals between any of the components (e.g., 102, 106, 108, or 120) of the environment 100. The network 104 may be wired or wireless. The network 104 may have numerous configurations including a star configuration, a token ring configuration, or another suitable configuration. Furthermore, the network 104 may include a local area network (LAN), a wide area network (WAN) (e.g., the Internet), and/or other interconnected data paths across which multiple devices may communicate. In some embodiments, the network 104 may include a peer-to-peer network. The network 104 may also be coupled to or include portions of a telecommunications network that may enable communication of data in a variety of different communication protocols.

In some embodiments, the network 104 includes or is configured to include a BLUETOOTH® communication network, a Z-Wave® communication network, an Insteon® communication network, an EnOcean® communication network, a wireless fidelity (Wi-Fi) communication network, a ZigBee communication network, a HomePlug communication network, a Power-line Communication (PLC) communication network, a message queue telemetry transport (MQTT) communication network, a MQTT-sensor (MQTT-S) communication network, a constrained application protocol (CoAP) communication network, a representative state transfer application protocol interface (REST API) communication network, an extensible messaging and presence protocol (XMPP) communication network, a cellular communications network, any similar communication networks, or any combination thereof for sending and receiving data. The data communicated in the network 104 may include data communicated via short messaging service (SMS), multimedia messaging service (MMS), hypertext transfer protocol (HTTP), direct data connection, wireless application protocol (WAP), e-mail, smart energy profile (SEP), ECHONET Lite, OpenADR, or any other protocol that may be implemented with the user device 102, the server 106, the computing device 108, or the data source 120.

The data source 120 may include any memory or data storage. The data source 120 may include network communication capabilities such that other components in the environment 100 may communicate with the data source 120. In some embodiments, the data source 120 may include computer-readable storage media for carrying or having computer-executable instructions or data structures stored thereon. The computer-readable storage media may include any available media that may be accessed by a general-purpose or special-purpose computer, such as a processor. For example, the data source 120 may include computer-readable storage media that may be tangible or non-transitory computer-readable storage media including Random Access Memory (RAM), Read-Only Memory (ROM), Electrically Erasable Programmable Read-Only Memory (EEPROM), Compact Disc Read-Only Memory (CD-ROM) or other optical disk storage, magnetic disk storage or other magnetic storage devices, flash memory devices (e.g., solid state memory devices), or any other storage medium which may be used to carry or store desired program code in the form of computer-executable instructions or data structures and that may be accessed by a general-purpose or special-purpose computer. Combinations of the above may be included in the data source 120.

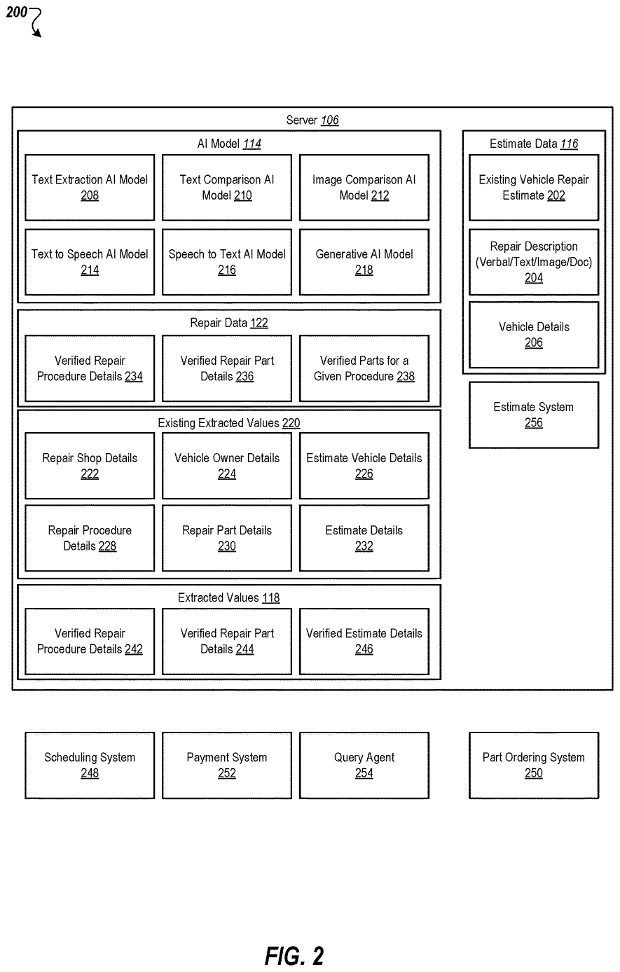

FIG. 2 illustrates a block diagram 200 of example components, example systems, or example data sources used to estimate vehicle repair costs. With reference to FIGS. 1 and 2, the estimate data may include an existing vehicle repair estimate 202. The existing vehicle repair estimate 202 may include the repair estimate 101 of FIG. 1 or may be a different repair estimate. The existing vehicle repair estimate 202 may include information about at least one of the repair shop, the vehicle owner, the vehicle to be repaired, the repair procedure or procedures to be performed, the labor time estimate or estimates for the repair procedure or procedures, the part or parts to be used for the repair, and the price or prices of the labor and part or parts as well as totals or any other details commonly associated with vehicle repair. The estimate data 116 may include a repair description 204. The repair description 204 may include a verbal and/or text and/or an image and/or a document or any other form of data. In addition, the repair description 204 may include information about at least one of the vehicle to be repaired, the repair procedure or procedures to be performed, the labor time estimate or estimates for the repair procedure or procedures, the part or parts to be used for the repair, and the price or prices of the labor and part or parts as well as total or totals or any other details commonly associated with vehicle repair. The estimate data 116 may include vehicle details 206 which may include but is not limited to a vehicle identification number (VIN), production year, make, model, trim-level, engine type, mileage, and any other characteristics of the vehicle.

The AI model 114 may include one or more sub or separate AI models 208, 210, 212, 214, 216, 218. The text extraction AI model 208 may be utilized to extract text from documents or images or text or structured or unstructured data of any kind. The text extraction AI model 208 may be trained using information about vehicle repair procedures and vehicle repair parts. The text comparison AI model 210 may be utilized to perform fuzzy comparison of text. The text comparison AI model 210 may be trained on a corpus of data which enables the model to interpret data at a conceptual level and this training data may also include information about vehicle repair procedures and vehicle repair parts. The image comparison AI model 212 may be utilized to compare images. The image comparison AI model 212 may be trained using image data which may include images of vehicle parts.

The text to speech AI model 214 may be utilized to convert text to speech. The speech to text AI model 216 may be utilized to convert speech to text. The generative AI model 218 may be utilized to generate text given inputs of various types including text, documents, images, video, audio, structured data and unstructured data. The generative AI model 218 may be trained on a corpus of data which enables the model to interpret data at a conceptual level. This training data may also include information about vehicle repair procedures and vehicle repair parts.

As shown in FIG. 2, the example components, systems, or data sources may include an example scheduling system 248, an example part-ordering system 250, or some combination thereof. The scheduling system 248 or the part-ordering system 250 may be any system associated with a vehicle part vendor and/or vehicle part retailer and/or vehicle part wholesaler and/or vehicle part manufacturer. The scheduling system 248 and the part-ordering system 250 are illustrated in FIG. 2 as being separate from the server 106. For example, the scheduling system 248, the part-ordering system 250, or both may be implemented on the computing device 108 of FIG. 1. Alternatively, the scheduling system 248, the part-ordering system 250, or both may be within and implemented on the server 106.

The example components, systems, or data sources may include an example payment system 252, an example query agent 254, or some combination thereof. The payment system 252 or the query agent 254 may include any system and/or any data source and/or search engine which may be queried for information. The payment system 252 and the query agent 254 are illustrated in FIG. 2 as being separate from the server 106. For example, the payment system 252, the query agent 254, or both may be implemented on the computing device 108 of FIG. 1. Alternatively, the payment system 252, the query agent 254, or both may be within and implemented on the server 106.

The repair data 122 may include verified repair procedure details 234, verified repair part details 236, verified parts for a given procedure 238, or some combination thereof. The verified parts for a given procedure 238 may indicate vehicle parts to be used for a given repair procedure.

In some embodiments, the existing extracted values 220 may be inaccurate, such as by having inflated labor time estimates, or inflated labor costs, or inflated part costs due to a repair shop attempting to overcharge for services or alternately the extracted values may be inaccurate due to incorrectly determined labor costs, part costs, parts to be repaired, or any other appropriate aspect.

The existing extracted values 220 may include repair shop details 222. The repair shop details 222 may include but is not limited to the repair shop name, the repair shop address, the repair shop's phone number and/or fax number, any email addresses associated with the repair shop, any websites associated with the repair shop, or any other details about the repair shop. The existing extracted values 220 may include vehicle owner details 224. The vehicle owner details 224 may include but is not limited to the owner's name, address, phone number, email address, or any other contact information or notes. The existing extracted values 220 may include estimate vehicle (e.g., the vehicle to be repaired) details 226. The estimate vehicle details 226 may include but is not limited to a vehicle identification number (VIN), production year, make, model, trim-level, engine type, mileage, and any other characteristics of the vehicle to be repaired.

The existing extracted values 220 may include repair procedure details 228. The repair procedure details 228 may include but is not limited to a description of the repair procedure and any related labor time estimates for the procedure or related costs for said labor. The existing extracted values 220 may include repair part details 230. The repair part details 230 may include but is not limited to any combination of the description of the part, the part name, part number, or part cost. The existing extracted values 220 may include estimate details 232. The estimate details 232 may provide but is not limited to totals for labor time, labor cost, and part cost.

The extracted values 118 may include values that are accurate or verified as described above. The extracted values 118 may include verified repair procedure details 242. The verified repair procedure details 242 may include but is not limited to a description of the repair procedure and any related labor time estimates for the procedure and related costs for said labor. The extracted values 118 may include verified repair part details 244. The verified repair part details 244 may include but is not limited to any combination of the description of the part, the part name, part number, or part cost. The extracted values 118 may include verified estimate details 246. The verified estimate details 246 may include but is not limited to totals for labor time, labor cost, or part cost. As shown in FIG. 2, the server 106 may include or form part of an estimate system 256. Alternatively, the estimate system 256 may be implemented on the computing device of FIG. 1.

In one example embodiment, the AI model 114 or one or more of the AI models 208, 210, 212, 214, 216, or 218 may be an OpenAI model such as GPT-2, GPT-3, GPT-4 or any prior or successive models from OpenAI, or an Anthropic model such as Claude 2 or Claude 3 or any prior or successive models from Anthropic, or a Google model such as Bard or Gemini or any prior or successive models from Google, or a Facebook model such as LLaMa or any prior or successive models from Facebook, or any Mistral AI model, or any of the present or future models on Huggingface.co, or any proprietary AI model, or any combination of all of these various models.

In one example embodiment, the verified repair procedure details 234, the verified repair part details 236, or the verified parts for a given procedure 238 may be obtained from any appropriate data source (e.g., the data source 120 of FIG. 1). Alternatively, the verified repair procedure details 234, the verified repair part details 236, or the verified parts for a given procedure 238 may be generated by the AI model 114 or the AI models 208, 210, 212, 214, 216, or 218.

In one example embodiment, the Query Agent 254 may be any database and/or any AI model and/or any Search Engine or any combination of these.

In one example embodiment, the AI models 214 or 216 may be AI models accessible via the Web Speech API in a modern web browser and/or the Speech Framework on Apple iOS devices and/or the “android.speech” implementation interfaces and classes on Android devices and any other similar interfaces.

The text extraction AI model 208 may be configured to operate using a detailed prompt to request any combination of the repair shop details 222, the vehicle owner details 224, the estimate vehicle details 226, the repair procedure details 228, the repair part details 230, or the estimate details 232. to be extracted from the existing vehicle repair estimate 202, the repair description 204, or the vehicle details 206 of the estimate data 116. Additionally, the text extraction AI model 208 may operate as if it is skilled in the art of vehicle repair. By way of example, but not limited to this example, an AI prompt that may be used for the text extraction AI model 208 may have a form similar to the following quoted text:
“You are an expert in vehicle maintenance and repair and are able to carefully and in great detail understand paperwork associated with this field. The attached file(s) is a bid/quote/invoice/estimate for the repair of a vehicle. Scan all of the attached and step-by-step identify and return all of these items:
   1) The vehicle owner
   2) The vehicle owner's contact information including address, phone number, email address, etc.
   3) The vehicle's year, make, model, trim level, engine type, mileage and VIN
   4) The repair shop
   5) The repair shop contact information including address, phone, email, etc.
   6) Identify each individual repair procedure/task by name and if possible also identify any associated labor time estimate
   7) If a repair procedure/task has any associated parts then identify those parts including the part name, part description, part cost and part number(s)
   8) If there are any parts that are not associated with a repair procedure/task then also identify those parts including the part name, part description, part cost and part number(s)
   9) Identify any totals including totals for labor times, totals for part costs, totals for labor costs, and any grand total cost.”

The text comparison AI model 210 may be configured to operate using a detailed AI prompt to perform a “fuzzy comparison” to a set of known repair procedures or the verified repair procedure details 234. The verified repair procedure details 234 may include associated labor times or other identifiers to a repair description or the repair procedure details 228, a part description or the repair part details 230, or both to identify the verified repair procedure details 242. By way of example, but not limited to this example, an AI prompt that may be used for the text comparison AI model 210 may have a form similar to the following quoted text, where the context in the below query is the verified repair procedure details 234 and the ${repairTask} text is substituted with the values of the repair procedure details 228 and/or the repair part details 230:
“You are an expert in vehicle maintenance and repair and are able to carefully and in great detail understand paperwork associated with this field. Answer the following question based only on the provided context. Your task is to ONLY return repair procedure ID values from the provided context, or 0 if no matching repair procedures are found, and nothing else. The provided context is a known list of automotive repair procedures/tasks. Compare the context's values to find any repair procedures which most closely match any procedures described within the block denoted by <queryitem> and </queryitem> and return the matching IDs, or return 0 if no similar match is found <queryitem>${repairTask}</queryitem>. Return ONLY the matching ID values (or 0 if not found) and NOTHING ELSE.”

As disclosed in FIG. 2, the verified repair procedure details 234 may represent a set of known repair procedures specific to a given vehicle type, including but not limited to vehicle production year, make, model, trim-level and engine type, and may include a description of a repair procedure as well as estimated labor times for the procedure and other information such as an identifying number and/or identifying code for the procedure.

The text comparison AI model 210 may be configured to operate using a detailed AI prompt to request that the model perform a “fuzzy comparison” between the repair part details 230 and the verified repair part details 236 to identify matching parts as the verified repair part details 244. By way of example, but not limited to this example, an AI prompt that may be used for the text comparison AI model 210 may have a form similar to the following quoted text, where the context in the below query is the verified repair part details 236 and the ${repairPart} text is substituted with the values of the repair part details 230:
“You are an expert in vehicle maintenance and repair and are able to carefully and in great detail understand paperwork associated with this field. Answer the following question based only on the provided context. Your task is to ONLY return repair part ID values from the provided context, or 0 if no matching repair parts are found, and nothing else. The provided context is a reliable list of automotive repair parts. Compare the context's values to find any repair parts which most closely match any parts described within the block denoted by <queryitem> and </queryitem> and return the matching IDs, or return 0 if no similar match is found <queryitem>${repairPart}</queryitem>. Return ONLY the matching ID values (or 0 if not found) and NOTHING ELSE.”

The verified repair part details 236 may represent any combination of at least but not limited to the part name, part description, part numbers, part price as well as an image of the part. The verified repair part details 236 may be obtained from any combination, but not limited to, a vehicle part manufacturer, a vehicle part retailer, any vehicle part wholesaler, or a vehicle OEM.

The image comparison AI model 212 may be configured to operate using a detailed AI prompt to request that the model perform a fuzzy comparison of two or more images to determine if the items pictured in the image are deemed to be equivalent, meaning they are identical or include compatible parts. By way of example, but not limited to this example, the AI prompt that may be used with the image comparison AI model 212 may have a form similar to the following quoted text, and the AI prompt may be accompanied by multiple attached images and/or documents:
“You are an expert in vehicle maintenance and repair and are able to carefully and in great detail understand paperwork associated with this field. Answer the following question based only on the attached files. The attached files contain images which depict vehicle repair parts. Analyze these attached files and determine if the depicted parts are identical parts. The parts may be photographed from different angles with different lighting and the parts may be different colors while still being identical. Respond with ‘MATCH’ if the parts are identical and/or conceptually similar and/or likely to be compatible, otherwise respond with ‘NOT A MATCH’.”

Although only single instances of the items are disclosed in the block diagram 200 of FIG. 2, it is understood that each of the items 114, 116, 118, 122, 202, 204, 206, 208, 210, 212, 214, 216, 218, 220, 222, 224, 226, 228, 230, 232, 234, 236, 238, 242, 244, 246, 248, 250, 252, or 254 inclusive, may instead include multiple instances (e.g., two or more items).

Having described one specific arrangement with respect to FIG. 2, it is understood that the specific arrangement of FIG. 2 is only one of countless arrangements in which the example methods disclosed herein may be employed. The scope of the example embodiments is not intended to be limited to any particular environment.

Modifications, additions, or omissions may be made to the example components, systems, or data sources of FIG. 2 without departing from the scope of the present disclosure. For example, the designations of different elements in the manner described is meant to help explain concepts described herein and is not limiting. Further, the example components, systems, or data sources may include any number of other elements or may be implemented within other systems or contexts than those described.

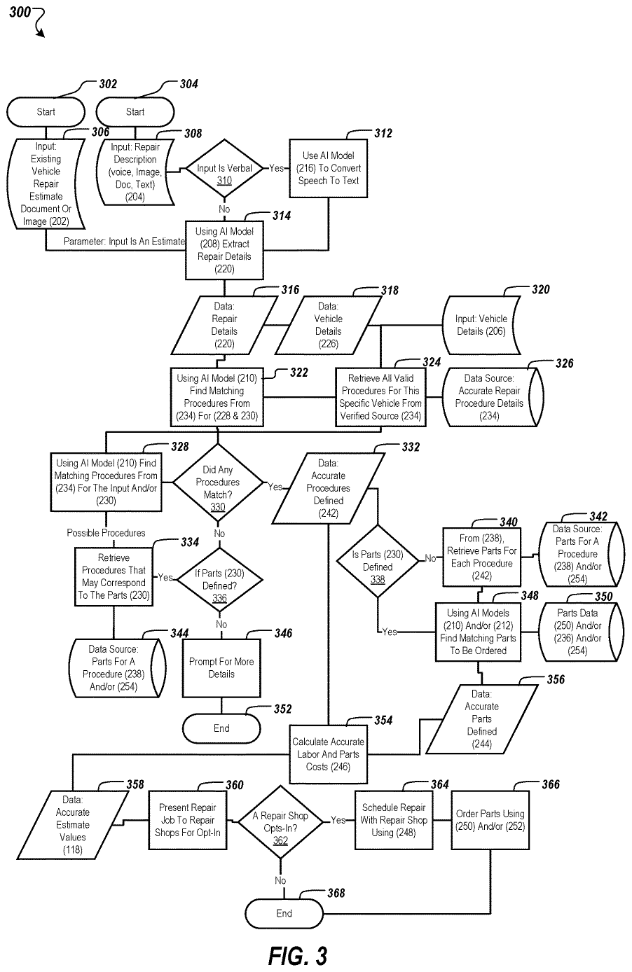

FIG. 3 is an example schematic flowchart diagram of an example method 300 of estimating vehicle repair costs given an existing repair estimate and/or a repair description, utilizing but not limited to any combination of the items in FIGS. 1 and 2 where there may be any number of examples of any of the items in FIG. 2. The method 300 may be implemented, in at least some embodiments, by the server 106 of FIG. 1 or the estimate system 256 of FIG. 2. For example, the server 106 may include one or more programs stored on one or more non-transitory computer-readable media that are configured, when executed, to cause one or more processors to perform operations of estimating vehicle repair costs given an existing repair estimate and/or a repair description as represented by one or more of the steps 302-370 of the method 300. Although illustrated as discrete steps, various steps may be divided into additional steps, combined into fewer steps, reordered, or eliminated, depending on the desired implementation. The method 300 will now be discussed with reference to FIGS. 1-3.

The method 300 may include block 302 where processing begins with block 306 in which the server 106 receives the existing vehicle repair estimate. Block 302 may be followed by block 314, including optionally passing contextual parameter information indicating that the existing vehicle repair estimate 202 is an existing repair estimate. Block 314 is described in more detail below. The method 300 may include block 304 where processing begins with block 308 in which the server 106 receives the repair description 204. Block 308 may be followed by block 310 in which the server 106 determines if the repair description 204 is verbal.

If the repair description 204 is verbal, block 310 may be followed by block 312. At block 312, the server 106 may execute the speech to text AI model 216 to convert the audio of the repair description 204 into text form and block 312 may be followed by block 314. If the repair description 204 is not verbal, block 310 may be followed by block 314. Examples of the repair description not being verbal may include one or more combinations of any number of images, documents, text or other data. At block 314, the server 106 may execute the text extraction AI model 208 to extract the existing extracted values 220 from the existing vehicle repair estimate 202, or from the repair description 204 where the repair description, if verbal, has been previously converted into text using the speech to text AI model 216 at block 312. At block 316, the server 106 may define the existing extracted values 220. Block 316 may be followed by block 322 and block 318.

At block 322, the server 106 may execute the text comparison AI model 210 to compare the repair procedure details 228 and/or the repair part details 230 with a fuzzy comparison to find matching vehicle-specific repair procedures from the verified repair procedure details 234 returned by block 324, which is described below.

At block 318, the server 106 may identify the estimate vehicle details 226 based on an outcome of block 320 in which the vehicle details 206 have been input. At block 324, the server 106 may retrieve the valid procedures for this specific vehicle from the verified repair procedure details 234 that are received at block 326. At block 330, the server 106 may determine whether or not any matching procedures were found at block 322. If the server 106 determines there are matching procedures, block 330 may be followed by block 332. If the server 106 determines there are no matching procedures, block 330 may be followed by block 336.

At block 336, the server 106 may determine whether or not any repair part details 230 were defined. If the server 106 determines there are no defined repair part details 230, block 336 may be followed by block 346 at which the server 106 may prompt for more details. If the server 106 determines that there are defined repair part details 230, block 336 may be followed by block 334. If no prompt is received, the method 300 may proceed to block 352 at which the method 300 ends. At block 334, the server 106 may retrieve repair procedures which correspond to the repair part details 230 from the verified parts for a given procedure 238 and/or the query agent 254 received at block 344.

Block 334 may be followed by block 328, at which, similarly to block 322, the server 106 may execute the text comparison AI model 210 to compare the procedures identified at block 334 and/or the repair part details 230 with a fuzzy comparison to find matching vehicle-specific repair procedures from the verified repair procedure details 234 returned at block 324. Block 328 may be followed by block 330. In some embodiments, if block 330 had previously been executed, block 328 may be followed by block 346 to avoid a potential infinite loop.

At block 332, the server 106 may define the verified repair procedure details 242. Block 332 may be followed by block 338, the server 106 may determine whether or not any repair part details 230 have been defined. If the repair part details 230 have been defined, block 338 may be followed by block 348, which is described below. If the repair part details 230 have not been defined, block 338 may be followed by block 340.

At block 340, the server 106 may utilize block 342 to access the verified parts for a given procedure 238 and/or the query agent 254 to retrieve parts corresponding to the verified repair procedure details 242.

At block 348, the server 106 may execute the text comparison AI model 210, the image comparison AI model 212 to query parts data at a step 350 from the part-ordering system 250, the verified repair part details 236, or the query agent 254 to find matching parts to be ordered. At block 356, the server 106 may define the verified repair part details 244.

At block 354, the server 106 may calculate estimate details such as total labor costs, total part costs, or grand total cost. At block 358, the server 106 may determine the extracted values 118. At block 360, the server 106 may present the details of the repair represented by the extracted values 118 (e.g., repair estimate 101) to candidate repair shops. The server 106 may provide multiple repair shops with the option to perform the repairs specified in the extracted values 118 (e.g., the repair estimate 101).

At block 362, the server 106 may determine if a repair shop opts-in. If a repair shop opts-in, block 362 may be followed by block 364. If no repair shop opts-in, block 362 may be followed by block 368 at which the method 300 may end.

At block 364, the server 106 may schedule the repair using the scheduling system 248. At block 364, the server 106 may schedule the repair only after a specific time, such as when the parts are to be delivered and/or have been confirmed to be delivered to the repair shop. Block 364 may be followed by block 366 at which the server 106 may order the parts specified by the verified repair part details 244 using the part ordering system 250. Additionally or alternatively, at block 366, the server 106 may also utilize the payment system 252. Although block 362 is described as involving an opt-in process, at block 362, the server 106 may perform an auction process with public or private/silent bidding from various repair shops. The method 300 may also include additional steps whereby the user is shown labor and/or part cost savings which may be computed by comparing labor cost to discounted labor cost and/or comparing part cost to discounted part cost.

It is understood that the steps of the method 300 performed in the examples above may be performed by a module other than the estimate system 256 such as with one or more microservices or any combination of hosts and/or services.

Modifications, additions, or omissions may be made to the method 300 without departing from the scope of the present disclosure. For example, the operations of method 300 may be implemented in differing order. Additionally or alternatively, two or more operations may be performed at the same time. Furthermore, the outlined operations and actions are only provided as examples, and some of the operations and actions may be optional, combined into fewer operations and actions, or expanded into additional operations and actions without detracting from the essence of the described embodiments.

FIG. 4 illustrates an example computing system 400 that may be used to automate auditing and generation of repair estimates, in accordance with at least one embodiment of the present disclosure. The computing system 400 may be configured to implement or direct one or more operations associated with the server 106, the user device 102, or the computing device 108 of FIG. 1. The computing system 400 may include a processor 402, memory 404, data storage 406, and a communication unit 408, which all may be communicatively coupled. In some embodiments, the computing system 400 may be part of any of the systems or devices described in this disclosure. For example, the computing system 400 may be configured to perform one or more of the tasks described above with respect to the server 106, the computing device 108, or the user device 102.

The processor 402 may include any computing entity, or processing device including various computer hardware or software modules and may be configured to execute instructions stored on any applicable computer-readable storage media. For example, the processor 402 may include a microprocessor, a microcontroller, a parallel processor such as a graphics processing unit (GPU) or tensor processing unit (TPU), a digital signal processor (DSP), an application-specific integrated circuit (ASIC), a Field-Programmable Gate Array (FPGA), or any other digital or analog circuitry configured to interpret and/or to execute program instructions and/or to process data.

Although illustrated as a single processor in FIG. 4, it is understood that the processor 402 may include any number of processors distributed across any number of networks or physical locations that are configured to perform individually or collectively any number of operations described herein.

In some embodiments, the processor 402 may be configured to interpret and/or execute program instructions and/or process data stored in the memory 404, the data storage 406, or the memory 404 and the data storage 406. In some embodiments, the processor 402 may fetch program instructions from the data storage 406 and load the program instructions in the memory 404. After the program instructions are loaded into memory 404, the processor 402 may execute the program instructions.

For example, in some embodiments, the processor 402 may be configured to interpret and/or execute program instructions and/or process data stored in the memory 404, the data storage 406, or the memory 404 and the data storage 406. The program instruction and/or data may be related to automating the auditing or generation of a repair estimate such that the computing system 400 may perform or direct the performance of the operations associated therewith as directed by the instructions.

The memory 404 and the data storage 406 may include computer-readable storage media or one or more computer-readable storage mediums for carrying or having computer-executable instructions or data structures stored thereon. Such computer-readable storage media may be any available media that may be accessed by a computer, such as the processor 402.

By way of example, and not limitation, such computer-readable storage media may include non-transitory computer-readable storage media including Random Access Memory (RAM), Read-Only Memory (ROM), Electrically Erasable Programmable Read-Only Memory (EEPROM), Compact Disc Read-Only Memory (CD-ROM) or other optical disk storage, magnetic disk storage or other magnetic storage devices, flash memory devices (e.g., solid state memory devices), or any other storage medium which may be used to carry or store particular program code in the form of computer-executable instructions or data structures and which may be accessed by a computer. Combinations of the above may also be included within the scope of computer-readable storage media.

Computer-executable instructions may include, for example, instructions and data configured to cause the processor 402 to perform a certain operation or group of operations as described in this disclosure. In these and other embodiments, the term “non-transitory” as explained in the present disclosure should be construed to exclude only those types of transitory media that were found to fall outside the scope of patentable subject matter in the Federal Circuit decision of In re Nuijten, 500 F.3d 1346 (Fed. Cir. 2007). Combinations of the above may also be included within the scope of computer-readable media.

The communication unit 408 may include any component, device, system, or combination thereof that is configured to transmit or receive information over a network. In some embodiments, the communication unit 408 may communicate with other devices at other locations, the same location, or even other components within the same system. For example, the communication unit 408 may include a modem, a network card (wireless or wired), an infrared communication device, a wireless communication device (such as an antenna implementing 4G (LTE), 4.5G (LTE-A), and/or 5G (mmWave) telecommunications), and/or chipset (such as a Bluetooth® device (e.g., Bluetooth 5 (Bluetooth Low Energy)), an 802.6 device (e.g., Metropolitan Area Network (MAN)), a Wi-Fi device (e.g., IEEE 802.11ax, a WiMAX device, cellular communication facilities, etc.), and/or the like. The communication unit 408 may permit data to be exchanged with a network and/or any other devices or systems described in the present disclosure.

Modifications, additions, or omissions may be made to the computing system 400 without departing from the scope of the present disclosure. For example, in some embodiments, the computing system 400 may include any number of other components that may not be explicitly illustrated or described. Further, depending on certain implementations, the computing system 400 may not include one or more of the components illustrated and described.

The embodiments described herein may include the use of a special-purpose or general-purpose computer including various computer hardware or software modules, as discussed in greater detail below.

Embodiments described herein may be implemented using computer-readable media for carrying or having computer-executable instructions or data structures stored thereon. Such computer-readable media may be any available media that may be accessed by a general-purpose or special-purpose computer. By way of example, and not limitation, such computer-readable media may include non-transitory computer-readable storage media including RAM, ROM, EEPROM, CD-ROM or other optical disk storage, magnetic disk storage or other magnetic storage devices, flash storage or any other storage medium which may be used to carry or store desired program code in the form of computer-executable instructions or data structures and which may be accessed by a general-purpose computer, special-purpose computer, or virtual computer such as a virtual machine, or container such as a Docker container. Combinations of the above may also be included within the scope of computer-readable media.

Computer-executable instructions comprise, for example, instructions and data which cause a general-purpose computer, special-purpose computer, virtual computer such as a virtual machine or container such as a Docker container to perform a certain function or group of functions. Although the subject matter has been described in language specific to structural features and/or methodological steps, it is to be understood that the subject matter defined in the appended claims is not necessarily limited to the specific features or steps described above. Rather, the specific features and steps described above are disclosed as example forms of implementing the claims.

As used herein, the term “component” or “system” or “data source” may refer to software objects or routines that are executed on a computing system. The different components or systems or data sources described herein may be implemented as objects or processes that execute on a computing system. While the components and systems and data sources and methods described herein are preferably implemented in software, implementations in hardware or a combination of software and hardware are also possible and contemplated.

All examples and conditional language recited herein are intended for pedagogical objects to aid the reader in understanding the example embodiments and the concepts contributed by the inventor to furthering the art, and are to be construed as being without limitation to such specifically-recited examples and conditions.

As used in the present disclosure, terms used in the present disclosure and especially in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc.

Further, any disjunctive word or phrase presenting two or more alternative terms, whether in the description, claims, or drawings, should be understood to contemplate the possibilities of including one of the terms, either of the terms, or both terms. For example, the phrase “A or B” should be understood to include the possibilities of “A” or “B” or “A and B.”

What is claimed is:

1. A computer-implemented system for automated generation and auditing of a vehicle repair estimate, the system comprising:
a processor; and
a memory storing instructions that, when executed by the processor, cause the processor to:
receive estimate data associated with a repair of a vehicle, the estimate data including at least one of an existing vehicle repair estimate, a repair description, or vehicle details identifying the vehicle;
execute a text extraction artificial intelligence model to extract, from the estimate data, extracted values including at least one of repair shop details, vehicle owner details, estimate vehicle details, repair procedure details, repair part details, or estimate details;
execute a text comparison artificial intelligence model to perform a fuzzy comparison between the extracted repair procedure details and a verified repair procedure details specific to the vehicle to identify verified repair procedure details;
execute the text comparison artificial intelligence model to perform a fuzzy comparison between the extracted repair part details and the verified repair part details to identify verified repair part details;
calculate verified estimate details including at least one of total labor cost, total part cost, or grand total cost based on the verified repair procedure details and the verified repair part details; and
generate a vehicle repair estimate based on the verified repair procedure details, the verified repair part details, and the verified estimate details.

2. The system of claim 1, wherein the instructions further cause the processor to:
determine whether the repair description is verbal; and
when the repair description is verbal, execute a speech-to-text artificial intelligence model to convert the repair description into text prior to executing the text extraction artificial intelligence model.

3. The system of claim 1, wherein the instructions further cause the processor to:
execute an image comparison artificial intelligence model to perform a fuzzy comparison of images of repair parts to determine whether depicted parts are identical, compatible, or conceptually similar.

4. The system of claim 1, wherein the instructions further cause the processor to:
present the vehicle repair estimate to one or more repair shops;
receive, from at least one repair shop, an opt-in acceptance or a bid to perform the repair specified in the vehicle repair estimate;
when bids are received from more than one repair shop, facilitate a competitive bidding process in either an open auction format or a blind auction format;
select a repair shop based on at least one of bid price, repair shop rating, or geographic proximity to a vehicle owner; and
upon selection of the repair shop, schedule the repair using a scheduling system and order parts identified in the vehicle repair estimate using a part-ordering system.

5. The system of claim 1, wherein the text extraction artificial intelligence model is configured to operate using an artificial intelligence prompt that instructs the model to act as an expert in vehicle maintenance and repair, and wherein the text comparison artificial intelligence model is configured to operate using an artificial intelligence prompt that instructs the model to return only matching repair procedure identifier values or repair part identifier values from a provided context, or a zero value when no match is found.

6. A method to automate the auditing of an existing vehicle repair estimate, the method comprising:
identifying an existing vehicle repair estimate having a format of one or more documents and/or one or more images and/or text data; and
inputting at least one of the identified vehicle repair estimate into an AI model or a prompt to the AI model to specify that the AI model is to identify and/or extract, from the vehicle repair estimate, details including at least one of: a repair shop's details including at least one of the repair shop name, the repair shop address, the repair shop's phone number and/or fax number, any email addresses associated with the repair shop, any websites associated with the repair shop or any other details and/or notes about the repair shop, vehicle owner's details including at least one of the owner's name, address, phone number, email address or any other contact information or notes regarding the vehicle owner, vehicle details including at least one of a vehicle identification number (VIN), production year, make, model, trim-level, engine type, mileage, or any other characteristics of the vehicle, repair procedure or procedures details including at least one of a description of the repair procedure or procedures or any related labor time estimates for the procedure or procedures or related costs for said labor, repair part or parts details including at least one of the description of the part or parts, the part name or names, part number or numbers or part cost or costs, or estimate details indicating at least one of totals for all labor time, all labor cost, or all part cost.

7. The method of claim 6, wherein an AI model is used to perform a fuzzy comparison of the extracted repair procedure(s) with repair procedures for which accurate repair labor times are known, in order to identify matching procedures.

8. The method of claim 6, wherein an AI model is then used to perform a fuzzy comparison of the extracted repair part(s), comparing any combination of part name(s), part description(s), part number(s), part cost(s), and/or part image(s), with repair part(s) from various part retailer(s) and/or part vendor(s) and/or part manufacturer(s) and/or part wholesaler(s) and/or part OEM(s), in order to identify matching part(s).

9. The method of claim 8, wherein the most cost-effective matching part(s) are selected.

10. The method of claim 8, wherein the most reliable matching part(s) are selected.

11. The method of claim 8, wherein the most profitable part(s) are selected.

12. The method of claim 9, wherein at least one of:
a repair shop elects to opt-in to perform the repair specified by the assembled accurate repair estimate, or
the repair shop elects to bid for the work in competition with other bidding repair shops in either an open or blind auction.

13. The method of claim 11, wherein at least one of:
a repair shop elects to opt-in to perform the repair specified by the assembled accurate repair estimate; or
the repair shop elects to bid for the work in competition with other bidding repair shops in either an open or blind auction.

14. A method to automate the creation of a vehicle repair estimate, the method comprising:
identifying vehicle repair details which includes a format of one or more documents and/or one or more images and/or text data and/or voice data; and
inputting at least one of the identified vehicle repair details into an AI model or a prompt to the AI model to specify that the AI model is to identify and/or extract, from the vehicle repair details, information including at least one of: repair procedure or procedures details including at least one of a description of the repair procedure or procedures, repair part or parts details including at least one of the description of the part or parts, the part name or names, part number or numbers or part cost or costs.

15. The method of claim 14, wherein responsive to the repair details including voice data, inputting the voice data into an AI model for speech-to-text conversion to convert the voice data into text data.

16. The method of claim 14, wherein an AI model is used to perform a fuzzy comparison of the extracted repair procedure(s) with repair procedures for which accurate repair labor times are known, in order to identify matching procedures.

17. The method of claim 14, wherein an AI model is then used to perform a fuzzy comparison of the extracted repair part(s), comparing any combination of part name(s), part description(s), part number(s), part cost(s), and/or part image(s), with repair part(s) from various part retailer(s) and/or part vendor(s) and/or part manufacturer(s) and/or part wholesaler(s) and/or part OEM(s), in order to identify matching part(s).

18. The method of claim 14, wherein an accurate repair estimate is assembled including the repair procedure(s) for which accurate labor time(s) is/are known.

19. The method of claim 15, wherein at least one of:
a repair shop elects to opt-in to perform the repair specified by the assembled accurate repair estimate; or
the repair shop elects to bid for the work in competition with other bidding repair shops in either an open or blind auction.

20. The method of claim 18, wherein at least one of:
a repair shop elects to opt-in to perform the repair specified by the assembled accurate repair estimate; or
the repair shop elects to bid for the work in competition with other bidding repair shops in either an open or blind auction.
